(19) United States
(12) Patent Application Publication
(10) Pub. No.: US 2025/0307533 A1
(43) Pub. Date: Oct. 2, 2025

(54) INFORMATION PROCESSING METHOD AND APPARATUS, AND ELECTRONIC DEVICE

(71) Applicant: Beijing Zitiao Network Technology Co., Ltd., Beijing (CN)

(72) Inventors: Shuang CHEN, Beijing (CN); Qing MU, Beijing (CN); Yingdi SUN, Beijing (CN); Ou DUAN, Beijing (CN); Feng WANG, Beijing (CN); Weiwen YI, Beijing (CN); Wenyan GENG, Beijing (CN); Juan DU, Beijing (CN)

(21) Appl. No.: 18/862,919

(22) PCT Filed: Aug. 17, 2023
(86) PCT No.: PCT/CN2023/113489

§ 371 Date: Nov. 4, 2024

(30) Foreign Application Priority Data
Oct. 28, 2022 (CN) 202211332034.1

(51) Int. Cl. G06F 40/169

(52) U.S. Cl. CPC G06F 40/169

(57) ABSTRACT

Embodiments of the present disclosure disclose an information processing method and apparatus, and an electronic device. A specific embodiment of the method includes: displaying information to be confirmed of a word to be edited; and on the basis of an operation on said information, establishing an association relationship said word and said information, where said information is used for providing explanatory information of said word.

### CROSS-REFERENCE TO RELATED APPLICATION(S)

This application is a U.S. National Stage under 35 U.S.C. § 371 of International Application No. PCT/CN2023/113489, as filed on Aug. 17, 2023, which is based on and claims priority to Chinese Patent Application No. 202211332034.1, filed on Oct. 28, 2022, and entitled “INFORMATION PROCESSING METHOD AND APPARATUS, AND ELECTRONIC DEVICE”, and the entire contents of each of these applications are incorporated herein by reference in its entirety.

### TECHNICAL FIELD

The present disclosure relates to the field of computer technologies, and in particular, to an information processing method and apparatus, and an electronic device.

### BACKGROUND

With the development of computers, users can use electronic devices to implement various functions. For example, users can obtain information through the electronic devices.

In some scenarios, a prerequisite for users to obtain information includes that a computer and human users perform a large amount of processing on the information. In this way, a wide range of information can be provided to the users. For example, users can edit information for publishing, and other users refer to the published information.

### SUMMARY

This section is provided to give a brief overview of concepts, which will be described in detail later in the section DETAILED DESCRIPTION OF EMBODIMENTS. This section is neither intended to identify key or necessary features of the claimed technical solutions, nor is it intended to be used to limit the scope of the claimed technical solutions.

According to a first aspect, an embodiment of the present disclosure provides an information processing method. The method includes: displaying information to be confirmed of a word to be edited; and establishing an association relationship between the word to be edited and the information to be confirmed based on an operation for the information to be confirmed, where the information to be confirmed is used to provide explanatory information of the word to be edited.

According to a second aspect, an embodiment of the present disclosure provides an information processing apparatus. The apparatus includes: a display unit configured to display information to be confirmed of a word to be edited; and an establishment unit configured to establish an association relationship between the word to be edited and the information to be confirmed based on an operation for the information to be confirmed, where the information to be confirmed is used to provide explanatory information of the word to be edited.

According to a third aspect, an embodiment of the present disclosure provides an electronic device. The electronic device includes: one or more processors; and a storage apparatus configured to store one or more programs, where when the one or more programs are executed by the one or more processors, the one or more processors are caused to implement the information processing method according to the first aspect.

According to a fourth aspect, an embodiment of the present disclosure provides a computer-readable medium having a computer program stored thereon, where when the program is executed by a processor, the steps of the information processing method according to the first aspect are implemented.

### BRIEF DESCRIPTION OF THE DRAWINGS

The above and other features, advantages, and aspects of the embodiments of the present disclosure become more apparent with reference to the following specific implementations and in conjunction with the accompanying drawings. Throughout the drawings, the same or similar reference numerals denote the same or similar elements. It should be understood that the accompanying drawings are schematic and that parts and elements are not necessarily drawn to scale.

FIG. 1 is a flowchart of an embodiment of an information processing method according to the present disclosure;

FIG. 2, FIG. 3, and FIG. 4 are schematic diagrams of an application scenario of the information processing method according to the present disclosure;

FIG. 5 is a schematic structural diagram of an embodiment of an information processing apparatus according to the present disclosure;

FIG. 6 is a schematic diagram of an example system architecture to which the information processing method of an embodiment of the present disclosure can be applied; and

FIG. 7 is a schematic diagram of a basic structure of an electronic device provided according to an embodiment of the present disclosure.

### DETAILED DESCRIPTION OF EMBODIMENTS

Embodiments of the present disclosure will be described in more detail below with reference to the accompanying drawings. Although some embodiments of the present disclosure are shown in the drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and the embodiments of the present disclosure are only for exemplary purposes, and are not intended to limit the scope of protection of the present disclosure.

It should be understood that the various steps described in the method implementations of the present disclosure may be performed in different orders, and/or performed in parallel. In addition, additional steps may be included and/or the execution of the illustrated steps may be omitted in the method implementations. The scope of the present disclosure is not limited in this respect.

The terms “include” and variations thereof as used herein are an open-ended inclusion, namely, “include but not limited to”. The term “based on” is “at least partially based on”. The term “an embodiment” means “at least one embodiment”; the term “another embodiment” means “at least one another embodiment”; and the term “some embodiments” means “at least some embodiments”. Related definitions of other terms will be given in the description below.

It should be noted that concepts such as “first” and “second” mentioned in the present disclosure are only used to distinguish different apparatuses, modules, or units, and are not used to limit an order or interdependence of functions performed by these apparatuses, modules, or units.

It should be noted that modifiers such as “one” and “a plurality of” mentioned in the present disclosure are illustrative rather than restrictive, and those skilled in the art should understand that unless the context clearly indicates otherwise, it should be understood as “one or more”.

Names of messages or information exchanged between a plurality of apparatuses in the implementations of the present disclosure are for illustrative purposes only, and are not used to limit the scope of these messages or information.

In some related technologies, users may reduce editing and publishing of information considering a time cost of editing the information and considering a difficulty of actively editing the information.

It should be noted that in the information processing method provided in this embodiment, the information to be confirmed of the word to be edited is displayed to the user for the user to confirm. In this way, a time for the first user to organize the explanatory information of the word to be edited can be reduced, and a difficulty for the user to provide the explanatory information can be reduced. Therefore, a difficulty in generating information can be reduced, accuracy of processing information can be improved, and then the information can be quickly expanded or updated.

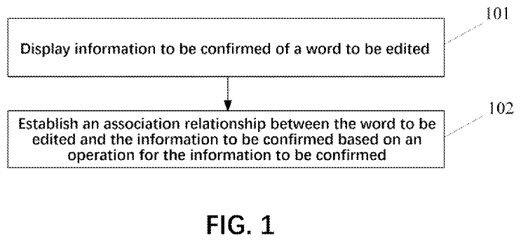

FIG. 1 is a flowchart of an embodiment of an information processing method according to the present disclosure. As shown in FIG. 1, the information processing method includes the following steps.

Step 101: Display information to be confirmed of a word to be edited.

In this embodiment, an execution subject (for example, a server and/or a terminal device) of the information processing method may display information to be confirmed of a related word of a first user.

Here, the word to be edited may be a source whose explanatory information is to be edited and/or whose explanatory information is to be provided. In other words, if explanatory information of a word or a source providing the explanatory information still needs to be supplemented, the word may be referred to as the word to be edited.

Here, the information to be confirmed may be information that needs to be determined by the first user. As an example, the first user may be a currently logged-in user, that is, a user indicated by a current account.

As an example, the information to be confirmed may include but is not limited to at least one of the following: a word definition, a related document, a related group, a related user identifier, a related link, and a related word.

Step 102: Establish an association relationship between the word to be edited and the information to be confirmed based on an operation for the information to be confirmed.

In this embodiment, the information to be confirmed is used to provide explanatory information of the word to be edited.

Here, in terms of an operation form, the operation for the information to be confirmed may include any form of operation form, which is not limited here.

Here, in terms of an effect, the operation for the information to be confirmed may include but is not limited to at least one of the following: a confirmation operation, a non-confirmation operation, a to-be-determined operation (for example, a control marked with Ignore), and a content editing operation.

Here, based on the foregoing operation, it may be determined whether to establish the association relationship between the word to be edited and the information to be confirmed.

For example, in response to the confirmation operation for the information to be confirmed, the association relationship between the word to be edited and the information to be confirmed is established.

It should be noted that in the information processing method provided in this embodiment, the information to be confirmed of the word to be edited is displayed to the user for the user to confirm. In this way, a time for the first user to organize the explanatory information of the word to be edited can be reduced, and a difficulty for the user to provide the explanatory information can be reduced. Therefore, a difficulty in generating information can be reduced, accuracy of processing information can be improved, and then the information can be quickly expanded or updated. In some application scenarios, the information generation method in this embodiment of the present application may be applied to knowledge accumulation. In these application scenarios, the word to be edited may include an entry for knowledge accumulation, and the information to be confirmed may include at least one of the following: a word definition, a related document, a related group, a related user identifier, a related link, and a related word. Knowledge accumulation may be performed inside an organization or on the Internet. For example, in an enterprise organization, knowledge accumulation may help users understand some knowledge such as fixed terms, reduce a communication understanding cost, and improve communication effectiveness inside the enterprise organization.

In these application scenarios, the information to be confirmed of the word to be edited is displayed, and the association relationship between the word to be edited and the information to be confirmed is established based on the operation for the information to be confirmed. In this way, a new information processing manner may be provided. In this information processing manner, the information to be confirmed may be displayed to the user for the user to confirm. In this way, a time for the first user to organize the explanatory information of the word to be edited can be reduced, and a difficulty for the user to provide the explanatory information can be reduced. Therefore, a difficulty in generating knowledge can be reduced, accuracy of generating the knowledge can be improved, and then the knowledge can be quickly expanded or updated.

In comparison, in some related technologies, knowledge accumulation is implemented through manual editing.

In this manner, the speed is slow, and the user needs to pay a high time cost.

In comparison, in some related technologies, knowledge accumulation is implemented through enterprise knowledge mined, for example, knowledge is mined through a machine algorithm, and accuracy of the knowledge cannot be ensured.

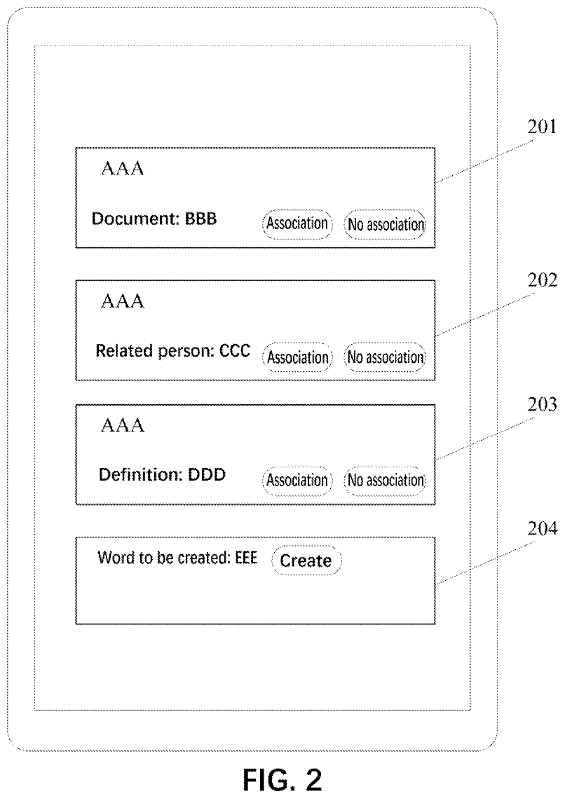

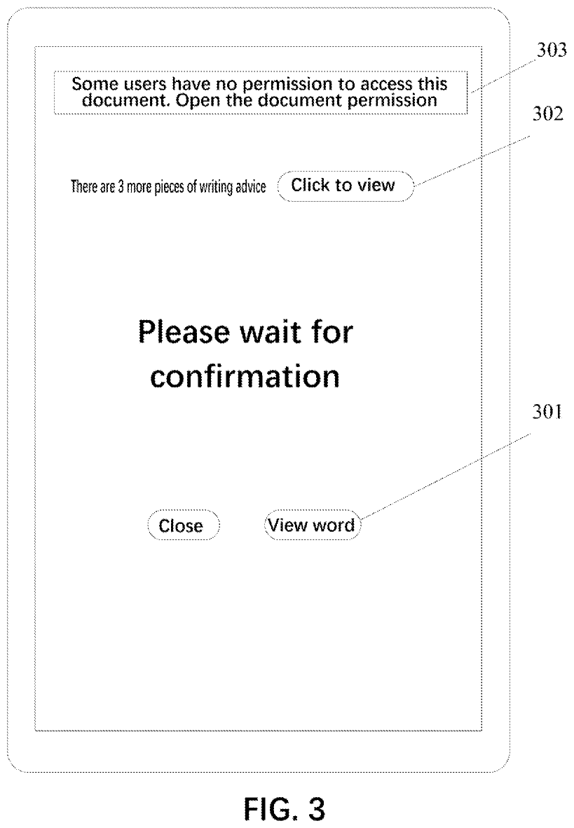

For example, referring to FIG. 2, FIG. 2 shows a preset interface scenario. In FIG. 2, a card 201 may display a related word AAA and a document BBB to be confirmed; a card 202 may display the related word AAA and a related person CCC to be confirmed; and a card 203 may display the related word AAA and a definition DDD to be confirmed.

In some embodiments, the word to be edited may include a related word pushed to the first user.

Here, the first user may be a currently logged-in user.

Here, the related word may be a word related to the first user. For example, a correlation between the user and the word may be obtained through mining.

It should be noted that the information to be confirmed of the related word is displayed to the first user, and the association relationship between the related word and the information to be confirmed is established based on the confirmation operation of the first user for the information to be confirmed. In this way, the information to be confirmed can be actively pushed to and displayed to the first user, to improve a probability of the first user editing the related word, and reduce a time for the first user to organize the explanatory information of the related word and a difficulty for the user to provide the explanatory information. Therefore, a difficulty in generating knowledge can be reduced, accuracy of generating the knowledge can be improved, and then the knowledge can be quickly expanded or updated.

In comparison, in some related technologies, a user actively expands or updates a word definition through manual editing. In this manner, the speed is slow, and the user needs to pay a high time cost.

In some embodiments, the method further includes: in response to a predefined expansion operation for the related word, displaying a definition of the related word, so that the first user determines, based on the definition, whether to perform the confirmation operation.

For example, the predefined expansion operation may include hovering a mouse over the related word. In other words, when the mouse hovers over the related word, the definition of the related word is triggered to be displayed. The foregoing first user may determine, based on the displayed definition, whether to perform the confirmation operation.

For example, referring to FIG. 2, when a user hovers a mouse over the AAA in the card 201, the definition of the AAA may be displayed, so that the first user determines, based on the displayed definition, whether to perform the confirmation operation for the document BBB to be confirmed.

It should be noted that the definition of the related word is displayed, which can help the user understand the related word, thereby reducing steps and time for the user to search for or recall by himself/herself, and quickly determining whether to perform the confirmation operation.

In some embodiments, the information to be confirmed of the related word is displayed in a preset interface, the preset interface includes at least two areas, and one related word and one piece of information to be confirmed of the related word are displayed in each area.

Here, the preset interface may be an interface of a pre-specified type.

A plurality of areas may be displayed in the preset interface, and different information to be confirmed is displayed in the different areas. In different areas, the related words may be the same, but the information to be confirmed of the related words is different. For example, a first area displays a first word and information to be confirmed of the first word; and a second area displays a second word and information to be confirmed of the second word. For example, the first area displays the first word and first-type information to be confirmed of the first word; and the second area displays the first word and second-type information to be confirmed of the first word.

It should be noted that the indication of the two areas is displayed in the preset interface, and one related word is displayed in each area, so that the related word and the information to be confirmed can be displayed in batch, and boundaries are made with different areas, so that different related words can be clearly distinguished, improving efficiency of the user in operating on the information to be confirmed of the related word.

In some embodiments, the preset interface includes but is not limited to at least one of the following: a knowledge base home page interface, an interface for displaying a set of words to be edited by the first user in a centralized manner, and an interface for receiving a word-related message of the first user.

Here, the knowledge base home page interface may be configured to display a knowledge base home page. For example, the knowledge base home page may include a search control, and the search control may be configured to receive a search word of the user. The information to be confirmed is displayed in the knowledge base home page interface, so that when the user uses the knowledge base, the user can understand the information to be confirmed that can be confirmed by himself/herself, improving a probability of the user confirming the information to be confirmed.

Here, the interface for displaying the set of words to be edited by the first user in a centralized manner may be configured to display the related words of the first user in a centralized manner, and the user can edit the related words of the user. The information to be confirmed is displayed in the interface for displaying the set of words to be edited by the user in a centralized manner, so that when the user edits the words in a centralized manner, the information to be confirmed is displayed, so that the user processes (including editing or confirming) the related words in a centralized manner. In this way, efficiency of processing the related words can be improved.

Here, the interface for receiving a word-related message may be configured to receive a word-related message. For example, the interface for receiving a word-related message may be configured to receive a related situation of a related word edited by the user within a period of time (for example, one week). The information to be confirmed is displayed in the interface for receiving a word-related message, so that when the word-related message is pushed to the user, the user can understand the information to be confirmed of the related word that can be confirmed by himself/herself, improving a probability of the user editing the information to be confirmed.

In some embodiments, the method further includes: displaying a word to be created by the first user, and displaying a creation control in a corresponding manner to the word to be created; and in response to a trigger operation for the creation control, displaying a word editing interface.

Referring to FIG. 2, FIG. 2 shows a word to be created by the first user and a corresponding creation control. The user clicks the creation control, and can jump to the word editing interface. In the word editing interface, the first user can edit the word to be created. In FIG. 2, a card 204 may display the word to be created (for example, a word to be created EEE) and the creation control (for example, a control marked with Create). The first user may trigger the creation control, and in response to the trigger for the creation control, the word editing interface is displayed, so that an editable interface can be immediately displayed to a user who intends to edit a word, to complete creation and editing of the word EEE.

It may be understood that the word to be created may not yet be formed into a word, and there is no explanatory information. The related word of the first user has been determined to be a word, and may have some explanatory explanations, or may not yet have explanatory information. The information to be confirmed may be the explanatory information that may be added to the related word.

It should be noted that the word to be created and the creation control are displayed to the user, and for a new word that may be mined as a word, the user confirms whether to create the word and whether to edit the word, so that accuracy of word creation can be improved. Then an editable interface can be immediately displayed to a user who intends to edit a word, improving a possibility of the user editing the word, and then efficiently completing creation and editing of the word.

In some embodiments, the method further includes: in response to the confirmation operation, displaying a word editing entry control of the related word; and in response to a trigger operation for the word editing entry control, displaying a word editing interface of the related word.

For example, referring to FIG. 3, FIG. 3 may display to the user that the user has confirmed the relationship between the related word and the information to be confirmed. FIG. 3 shows a word editing entry control 301. The word editing entry control is triggered (for example, clicked), and the word editing interface can be jumped to and displayed. In the word editing interface, the user can edit the related word.

It should be noted that the word editing entry control is displayed in response to the user performing the confirmation operation, which can prompt the user to further edit the word, improving a possibility of the user editing the related word, and then improving a completeness of the explanatory information of the word.

In some embodiments, the method further includes: in response to the confirmation operation, displaying editing prompt information of the related word, and displaying a word editing entry control corresponding to the editing prompt information; and in response to a trigger operation for the word editing entry control, displaying a word editing interface of the related word.

For example, referring to FIG. 3, FIG. 3 shows editing prompt information (for example, “There are still 3 pieces of writing suggestions” in FIG. 3) of the related word and a corresponding word editing entry control 302.

Here, the editing prompt information may prompt the user that there is content that may be edited in the related word. In this way, the user is prompted that the related word can be further edited.

It should be noted that the editing prompt information and the corresponding word editing entry control are displayed in response to the user performing the confirmation operation, which can explicitly prompt the user that the related word has a possibility of further editing, improving a possibility of the user editing the related word, and then improving a completeness of the explanatory information of the word.

In some embodiments, the information to be confirmed includes a related document identifier.

In some embodiments, step 102 may include: displaying an association control corresponding to the related document identifier; and establishing an association relationship between the related word and a related document indicated by the related document identifier based on a trigger operation for the association control.

Here, the related document identifier may indicate the related document. As an example, the document may include a cloud document.

Here, the related document may include explanatory information for explaining the related word.

It should be noted that first, the related word is explained by associating the related document, which can improve completeness and depth of the user's understanding of the related word; and second, the information to be confirmed includes the related document identifier, and the first user confirms a correlation between the related document and the related word, which can improve accuracy of the related document associated with the related word. Therefore, accuracy of the explanatory information of the related word is improved.

In some embodiments, the establishing an association relationship between the related word and a related document indicated by the related document identifier based on a trigger operation for the association control includes: in response to detecting the trigger operation for the association control, sending an association relationship confirmation request; and in response to receiving an association success notification returned based on the association relationship confirmation request, displaying association success prompt information.

Here, when the user confirms the association relationship between the related word and the information to be confirmed, the association relationship may be further confirmed by another user or a background program.

In some embodiments, the method further includes: in response to detecting the trigger operation for the association control, determining whether a publication scope of the related document indicated by the related document identifier is a preset scope; if the publication scope is not the preset scope, displaying permission opening prompt information; in response to a trigger operation for the permission opening prompt information, displaying a permission opening interface; and updating the publication scope of the related document based on an operation for a permission change control.

Here, the permission opening interface includes the permission change control.

Here, the preset scope may be set based on an actual application scenario. For example, the publication scope of the related document may include any one of the following, but is not limited to: being published to all users, being published to users in a specified group, and not being published to anyone. The preset scope may include any one of the following, but is not limited to: being published to all users, and being published to a specified user.

For example, referring to FIG. 3, FIG. 3 shows that if the scope of the related document is not the preset scope, permission opening prompt information 303 (for example, marked with “Some users have no permission to access this document. Open permission” in FIG. 3) may be displayed. The user clicks the permission opening prompt control 303, and the permission opening interface may be displayed. The permission change control may be displayed in the permission opening interface, and the publication scope of the related document can be updated based on the operation for the permission change control.

It should be noted that when the scope of the related document does not meet the preset scope, the first user is promptly reminded to adjust the publication scope of the related document, and permission is opened to a plurality of users through one operation, so that other users can timely and smoothly open the related document when referring to the related document to understand the related word; instead of applying for permission one by one when the plurality of other users need to refer to the related document, and the first user opens permission one by one.

In some embodiments, the information to be confirmed includes a related user identifier.

In some embodiments, step 102 may include: displaying an association control corresponding to the related user identifier; and establishing an association relationship between the related word and the related user identifier based on a trigger operation for the related user identifier.

Optionally, the related user identifier in the information to be determined may indicate the first user or another user other than the first user.

Here, the user having an association relationship with the related word may be a user who knows the related word better. The user may answer a question when another user has the question about the related word.

It should be noted that first, the related word is explained by associating the related user, which can prompt the user who can be asked when the user needs to further understand the related word, thereby improving completeness and depth of the user's understanding of the related word; and second, the information to be confirmed includes the related user identifier, and the first user confirms a correlation between the related user and the related word, which can improve accuracy of the related user associated with the related word. Therefore, accuracy of the explanatory information of the related word is improved.

In some embodiments, the information to be confirmed includes a candidate definition of the related word.

In some embodiments, step 102 may include: displaying a confirmation control corresponding to the candidate definition; and establishing an association relationship between the related word and the candidate definition based on a trigger operation for the confirmation control.

Here, the candidate definition may be obtained through mining.

It should be noted that first, the related word is explained by associating the candidate definition, which can prompt the user who can be asked when the user needs to further understand the related word, thereby improving completeness and depth of the user's understanding of the related word; and second, the information to be confirmed includes the candidate definition identifier, and the first user confirms a correlation between the candidate definition and the related word, which can improve accuracy of the candidate definition associated with the related word. Therefore, accuracy of the explanatory information of the related word is improved.

In some embodiments, the displaying information to be confirmed of a word to be edited includes: displaying, in a word editing interface of the word to be edited, the information to be confirmed of the word to be edited.

Optionally, the word editing interface may correspond to the word to be edited one to one. In other words, one word to be edited and the information to be confirmed of the word may be displayed in each word editing interface.

For example, referring to FIG. 4, FIG. 4 shows a word editing interface.

It should be noted that the information to be confirmed of the word to be edited is displayed in the word editing interface in a centralized manner, which can improve an efficiency of editing the word to be edited.

In some embodiments, the method further includes: in response to a trigger operation of a user having an editing permission for a word to be edited for a predefined word editing entry control, displaying the word editing interface.

Here, the word editing interface may be displayed in response to a user request. An entry control for entering a word editing page may be displayed in a plurality of interfaces. For example, the entry control for entering the word editing page may be displayed in at least one of the following, but is not limited to: a knowledge base home page interface, an interface for displaying a set of words to be edited by the first user in a centralized manner, and an interface for receiving a word-related message of the first user.

In some embodiments, the method further includes: displaying prompt information corresponding to the information to be confirmed.

Here, the prompt information is used to indicate at least one of the following of the information to be confirmed: a type, a source, and an operation prompt.

For example, referring to FIG. 4, prompt information 401 in FIG. 4 shows prompt information of a definition, where the definition in the prompt information 401 may indicate a type, and the source is obtained through mining, and Edit if inappropriate may be understood as an operation prompt. Prompt information 402 in FIG. 4 shows prompt information of a related document, where the document in the prompt information 402 may indicate a type, and the source is Your document. Remove if inappropriate may be understood as an operation prompt. As an example, the user may click an X corresponding to the document BBB to remove the document.

Here, the prompt information corresponding to the information to be confirmed is displayed, which can display related items of the information to be confirmed to the user, and prompt the user how to understand or operate on the information to be confirmed.

In some embodiments, the prompt information is displayed in a form of annotated content.

Here, the prompt information may be displayed in a form of annotation. Referring to FIG. 4, the prompt information may be displayed in a form of annotation.

It should be noted that the prompt information is displayed in the form of annotation, which can prominently display the prompt information, and clearly distinguish the information to be confirmed from the prompt information, improving a probability of the user learning information that can be improved through the prompt information.

In some embodiments, the operation for the information to be confirmed includes but is not limited to at least one of the following: a deletion operation, a confirmation operation, and an editing operation.

Here, the deletion operation may be to delete the information to be confirmed, to clarify that the information to be confirmed is not related to the word to be edited. As an example, the user may click “x” shown in FIG. 4 to perform the deletion operation.

Here, the confirmation operation may be used to determine an association relationship between the information to be confirmed and the word to be edited.

Here, the editing operation may be used by the user to edit the explanatory information of the word to be edited. As an example, the user may perform the editing operation in an edit control 403.

In some embodiments, the displayed information to be confirmed includes at least one of the following types, but is not limited to: a word definition, a related document, a related group, a related user identifier, a related link, and a related word.

Here, the related link is used to indicate a carrier of the explanatory information. A network resource in which the explanatory information is recorded is associated with the word to be edited by determining the related link of the word to be edited by the user, to expand a way for the user to obtain the explanatory information of the word to be edited. As an example, FIG. 4 shows a related link III.

Here, the word definition is confirmed by the user, which can save time consumed by the user entering the word definition, thereby improving enthusiasm of the user for completing editing the word definition. As an example, FIG. 4 shows a word definition DDD. The user may confirm or edit the DDD to make the definition more complete.

As an example, FIG. 4 shows a related document identifier BBB. Here, an accurate related document is set for the word to be edited by confirming the correlation between the related document and the word to be edited by the user, so that accurate information of the word to be edited can be conveniently obtained from the related document.

As an example, FIG. 4 shows a related group FFF. Here, by determining the related group by the user, the group can be associated with the word to be edited, so that content related to the word to be edited can be conveniently obtained from the group.

For example, FIG. 4 shows a related user identifier CCC. Here, by confirming the related user identifier by the user, the related user identifier can be associated with the word to be edited, to specify an accurate related user for the information to be edited. In this way, when another user wants to understand the word to be edited, the user can learn related content of the word to be edited from the related user associated with the word to be edited.

For example, FIG. 4 shows a related word JJJ. Here, by determining, by the user, an association relationship between the word to be edited and the related word, steps of searching for and finding the related word for the word to be edited can be saved, and the word to be edited can be understood conveniently through the related word.

In some embodiments, feedback information is displayed in the word editing interface. The feedback information includes improvement direction information for content to be edited of the word to be edited. For example, FIG. 4 shows feedback information 404, which indicates that a word category is still missing from the word to be edited.

It should be noted that the feedback information can prompt how to better edit the word to be edited, improving accuracy and completeness of editing.

In some embodiments, the method further includes: mining, from a database, related information of the word to be edited and an expected contribution user.

In some embodiments, the related information is used as the information to be confirmed, and the word to be edited is used as a related word of the expected contribution user, and the related word and the related information are pushed to the expected contribution user.

Here, the database may be a set of various information established based on user consent. For example, the database may include but is not limited to at least one of the following: a document and a chat record.

Here, the related information of the word to be edited may include at least one of the following, but is not limited to: a word definition, a related document, a related group, a related user identifier, a related link, and a related word.

Here, the expected contribution user may be a user who is expected to edit the word to be edited.

For example, for a word to be edited AAA, related information of the word to be edited may be mined from the database, where the related information includes at least one of the following: a related user, a related document, a candidate definition, and a related group; and an expected contribution user of the word to be edited may also be mined from the database. Then, the related information of the word to be edited may be sent to the expected contribution user as the information to be confirmed.

It should be noted that by mining the related information of the word to be edited and the expected contribution user, and pushing the related information of the word to be edited to the expected contribution user, to implement the expected contribution user determining a correlation between the related information and the word to be edited, a workload of the user editing the word can be reduced, thereby improving a probability of the user editing the word and a completeness and accuracy of the explanatory information of the word.

In some embodiments, the related word of the first user is obtained through the following steps: the related word of the first user is obtained through the following steps: in response to the first user being an expected contribution user of the word to be edited, using the related information of the word to be edited as the information to be confirmed, and using the word to be edited as the related word of the first user, and pushing the related word and the related information to the first user.

For example, a word to be edited AAA and a related document BBB are mined from the database, and an expected contribution user CCC of the word to be edited is mined. Then, the word to be edited AAA (that is, the related word) and the related document BBB (that is, the information to be confirmed) may be pushed to the expected contribution user CCC.

In this way, the related word and the information to be confirmed can be automatically pushed to the first user based on a data mining result, improving a probability of the first user confirming the related word, and improving a completeness and accuracy of information of the word to be edited.

In some embodiments, the word editing page is obtained through the following steps: in response to receiving a get request for the word editing interface, sending, to a requesting user of the word editing interface, related information of the word to be edited as information to be confirmed.

Here, the get request is used to obtain the word editing interface of the word to be edited. For example, the word editing interface may be the word editing interface shown in FIG. 4.

Here, the related information of the word to be edited may be sent to the requesting user who sends the get request as the information to be confirmed. The information to be confirmed may be displayed in the word editing interface, and the user confirms the information in the word editing interface.

In this way, in the word editing interface, the user can complete information of the word to be edited through a simple confirmation, without the need for the user to search for or organize editing language by himself/herself, improving efficiency of the user in completing the explanatory information of the word to be edited.

In some embodiments, the mining, from a database, related information of the word to be edited and an expected contribution user may include: searching, in a document set, for a sentence including the word to be edited as a first sentence set; selecting, from the first sentence set, a first sentence that meets a preset definition sentence condition as a second sentence set; extracting a subject word in a second sentence in the second sentence set, and if the extracted subject word matches the word to be edited, determining a word definition of the word to be edited based on the second sentence.

Here, the document set may include at least one document. A document may include at least one sentence.

In the document set, a sentence including the word to be edited is searched for in a document as the first sentence set. In the first sentence in the first set, the word to be edited may be a subject, a predicate, an object, an attribute, an adverbial, a complement, or the like. It may be understood that if the word to be edited is a less important word in the first sentence, it may be difficult to extract a definition of the word to be edited from the first sentence.

Here, a definition sentence in the first sentence may be determined based on the preset definition sentence condition. The definition sentence may be used as the second sentence.

Then, the subject word (for example, including a subject or an object) in the second sentence in the second sentence set is extracted. If the extracted subject word matches the word to be edited, the word definition of the word to be edited is determined based on the second sentence.

Here, that the subject word matches the word to be edited may include that the subject word is consistent with the word to be edited, may include that the subject word is partially consistent with the word to be edited (for example, the subject word is an abbreviation of the word to be edited, or the word to be edited is an abbreviation of the subject word), or may include that the subject word and the word to be edited are synonyms in different languages.

It should be noted that first, mining the word definition in the document set may implement automatic machine acquisition of the word definition. Second, the word to be edited is first used for initial screening, and then a definition sentence is determined from the initially screened first sentence, to ensure that a definition can be obtained from the sentence. The subject word is extracted from the determined definition sentence. When the extracted subject word matches the word to be edited, the word definition of the word to be edited is determined based on the definition sentence, which can ensure that a main content of the definition sentence is to explain the word to be edited, ensuring accuracy of the obtained word definition.

In some embodiments, the mining, from a database, related information of the word to be edited and an expected contribution user includes: searching, in a document set, for a document including the word to be edited in a document title and/or document content as a first document set; determining a second document from the first document set based on the document title, to obtain a second document set; and selecting a related document of the word to be edited from the second document set based on a correlation with the word to be edited and/or a document quality score.

Here, the second document set includes a document that explains the word to be edited.

Here, the correlation with the word to be edited may be used to indicate a correlation degree between the document and the word to be edited.

Here, the document quality score may be used to indicate document quality.

For example, in the document set, the word to be edited is matched in a document title and body text, to obtain a related document set including the word to be edited. Then the document is filtered based on the title, to obtain a document related to an introduction, a guide, and the like of the word.

It should be noted that mining the related document in the document set may implement automatic machine acquisition of the related document. Second, a document including the word to be edited is initially screened out, and then an explanatory document of the word to be edited is found based on the document title, to obtain a document with the main content of explaining the word to be edited. In addition, screening is performed based on the correlation with the word to be edited or the document quality score, to screen out a high-quality related document of the word to be edited, improving accuracy of the finally obtained related document.

In some embodiments, the correlation between the second document and the word to be edited may be determined through a first step, where the first step includes: determining the correlation between the second document and the word to be edited based on at least one of the following: presentation information and search click information of the word to be edited in the second document.

Here, the presentation information of the word to be edited in the second document is determined based on at least one of the following: a presentation position, a presentation style, and a quantity of occurrences.

The search click information is used to indicate: when the second document is included in a search result obtained by using the word to be edited as a search word, a click situation of the user on the second document. It should be noted that the presentation information of the word to be edited in the second document may accurately indicate whether the word to be edited is main content or explanatory content of the document. The search click information may be used to confirm a correlation between the document and the word to be edited by using search data of the user. Therefore, accuracy of the correlation between the second document and the word to be edited can be improved.

In some embodiments, the document quality score may be determined through a second step, where the second step includes: determining a document quality score of the second document based on reading data and evaluation data of the document in a preset time period.

For example, two aspects of scoring are performed on these documents: a quality score of the document is calculated based on information such as reading, likes, and collection of the document in a past period of time; and a correlation between the word and the current document is scored, where features used include but are not limited to presentation and click information of the word in the document, and a click situation of a related document when the word is searched for.

Optionally, if the word hit by the document is a polysemous word, a pre-established disambiguation model also needs to be called to determine a specific word referred to by the word after disambiguation.

In this way, a high-quality document most correlated with the word can be preferably selected based on a comprehensive document correlation score and the document quality score, and a related document to be associated and confirmed may be obtained after de-duplication is performed on a document associated with the online word.

In some embodiments, the mining, from a database, related information of the word to be edited and an expected contribution user includes: determining, based on user feature information and a correlation between a user and the word to be edited, an expected contribution value between the user and the word to be edited.

Here, the user feature information may represent features of the user.

Here, the expected contribution value is used to represent a probability of the user editing the word to be edited.

It should be noted that the foregoing expected contribution value is determined based on two types of information, that is, the correlation between the user and the word to be edited and the user feature information.

In this way, a user who can accurately define the word can be determined for the word to be edited, ensuring that the determined user has local knowledge related to the word to be edited. In addition, accuracy of the information provided by the user can be ensured based on features of the user.

In some embodiments, the correlation is determined based on at least one of the following, but is not limited to: a similarity between a word associated with the user and the word to be edited, and a quantity of times that the word to be edited is included in an interaction record of the user.

For example, the quantity of times that the word to be edited is included in the interaction record of the user belongs to a statistical feature between the user and the word, for example, a quantity of times that the user mentions a mined word in a document, a message, a search, and the like, and is a strong feature of a correlation between the user and the word.

For example, the similarity between the word associated with the user and the word to be edited may be determined based on a word portrait feature of the user, and the word portrait feature of the user is represented in a form of a word vector of the user, where the vector may represent the word associated with the user. If a vector of the word to be edited is more similar to the word vector of the user, a higher correlation exists between the word associated with the user and the word to be edited.

In some embodiments, the mining, from a database, related information of the word to be edited and an expected contribution user may include: determining an expected contribution user identifier of the word to be edited based on the expected contribution value; and pushing the information to be confirmed to a user indicated by the expected contribution user identifier.

Here, user identifiers may be sorted based on expected contribution values of different users for the word to be edited, and the first N user identifiers are selected as the expected contribution user identifiers based on a sorting result.

In some embodiments, the user feature information includes at least one of the following, but is not limited to: a quantity of times that the user creates and/or updates a word; user reliability information; and user identity information.

Here, the user reliability information is generated based on comment information about the word and/or the document.

For example, the quantity of times that the user creates and/or updates the word may be used to represent a contribution willingness of the user.

For example, the user reliability feature may include, for example, features such as word likes/dislikes and document reading, likes, and forwarding.

For example, the user identity information may include, for example, whether the user is a wiki administrator or a user with a preset identity in an organization.

For example, a known relationship between the user and the word may be used as a model training sample for model training, to obtain a trained model. Then for an unknown expected contribution value, the correlation between the user and the word to be edited and the user feature information may be used as model inputs to determine the expected contribution value (model output) between the user and the word to be edited.

In some embodiments, the mining, from a database, related information of the word to be edited and an expected contribution user includes: determining a candidate related user identifier of the word to be edited based on behavior data of a user for the word to be edited; and determining a related user identifier of the word to be edited from candidate user identifiers of the word to be edited based on a relationship between the candidate related user identifier and related information associated with the word to be edited.

Here, a related user of the word to be edited may be a person who is very familiar with the word. For example, similar products and platform-related words need to be associated with related users.

Optionally, the related information associated with the word to be edited includes but is not limited to at least one of the following: a related document, a related group, a related schedule, a related word definition, and a related user.

In some embodiments, the relationship between the candidate related user identifier and the related information associated with the word to be edited includes at least one of the following, but is not limited to: whether the user is an owner of a related document of the word to be edited; whether the user is an administrator of a related group of the word to be edited; whether the user is a contributor to content of the word to be edited; and whether a schedule topic of the user in a preset time period includes the word to be edited.

For example, people who most frequently interact with the corresponding word can be learned through display and click information of the word in different scenarios (for example, chat, document, and search), and the first M users who most frequently interact with the word can be obtained through summarization. Then a plurality of factors are used for secondary determination, for example, whether the user is an owner of a word-related document, whether the user is an administrator of a word-related group, whether the user is a contributor to current word content, and whether a current schedule topic of the user includes the current word, to obtain the X most related users of the current word.

In this way, the candidate related users can be first screened out based on the user behavior data, and then accurate related users can be determined for the word to be edited through screening of correlation with the related information that has been determined for the word to be edited.

In some embodiments, the mining, from a database, related information of the word to be edited and an expected contribution user includes: determining a correlation between the word to be edited and a candidate related word based on at least one of the following: co-occurrence information between words, whether words are associated with a same piece of related information, and whether a word definition includes another word; and determining a related word of the word to be edited based on the correlation.

For example, based on a document and instant messaging data, a co-occurrence relationship between words can be mined, because related words usually frequently appear together in a same context, and a document co-occurrence feature and a group chat co-occurrence feature can be obtained.

For example, based on related information (for example, a related document, a related group, and a related schedule) associated with a word, if different words are associated with a same piece of related information, there is a specific correlation between the words, and a word-word common resource (document, group, or user) feature can be obtained through statistical summarization.

For example, based on a word definition, if another word is explicitly mentioned in the word definition, there is a specific correlation between the words, and the correlation is used as a definition reference feature.

For example, a word correlation discrimination model may be trained by introducing contrastive learning based on the foregoing features. The first X related words of a word are calculated through the model, and a result is stored for online recommendation of the related words.

It should be noted that the accurate related word of the word to be edited can be obtained through screening based on the co-occurrence between the words, whether the words are associated with the same piece of related information, and whether the words include the other word.

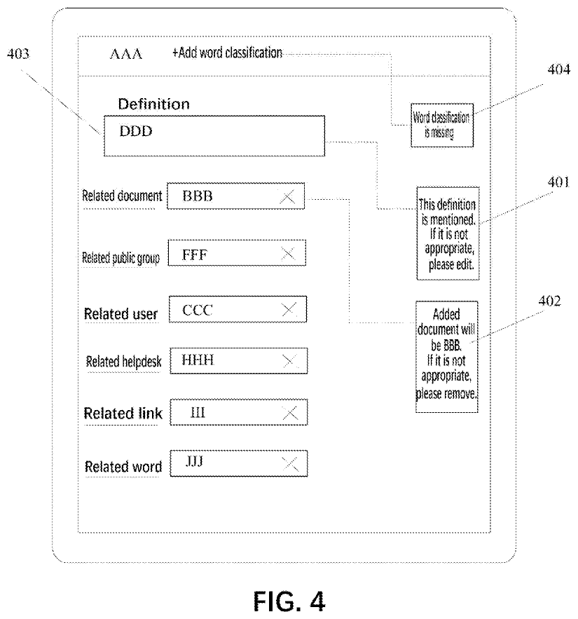

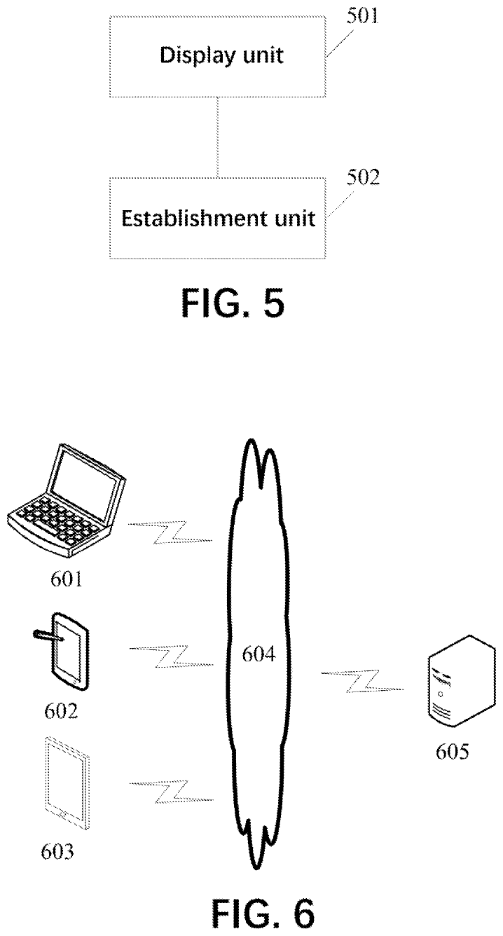

With further reference to FIG. 5, as an implementation of the method shown in the foregoing figures, the present disclosure provides an embodiment of an information processing apparatus. This apparatus embodiment corresponds to the method embodiment shown in FIG. 1, and the apparatus may be specifically applied to various electronic devices.

As shown in FIG. 5, the information processing apparatus in this embodiment includes: a display unit 501 and an establishment unit 502. The display unit 501 is configured to display information to be confirmed of a word to be edited. The establishment unit 502 is configured to establish an association relationship between the word to be edited and the information to be confirmed based on an operation for the information to be confirmed. The information to be confirmed is configured to provide explanatory information of the word to be edited.

In this embodiment, specific processing of the display unit 501 and the establishment unit 502 of the information processing apparatus and a technical effect brought about thereby may be respectively referred to the related descriptions of step 101 and step 102 in the corresponding embodiment of FIG. 1, and details are not described herein again.

In some embodiments, the word to be edited includes a related word pushed to a first user.

In some embodiments, the apparatus is further configured to: in response to a predefined expansion operation for the related word, display a definition of the related word, so that the first user determines whether to perform the confirmation operation based on the definition.

In some embodiments, the apparatus is further configured to: display a word to be created by the first user, and display a creation control in a corresponding manner to the word to be created; and in response to a trigger operation for the creation control, display a word editing interface.

In some embodiments, the apparatus is further configured to: in response to the confirmation operation, display a word editing entry control of the related word; and in response to a trigger operation for the word editing entry control, display a word editing interface of the related word.

In some embodiments, the apparatus is further configured to: in response to the confirmation operation, display editing prompt information of the related word, and display a word editing entry control corresponding to the editing prompt information; and in response to a trigger operation for the word editing entry control, display a word editing interface of the related word.

In some embodiments, the information to be confirmed includes a related document identifier; and the establishing an association relationship between the word to be edited and the information to be confirmed based on an operation for the information to be confirmed includes: displaying an association control corresponding to the related document identifier; and establishing an association relationship between the related word and a related document indicated by the related document identifier based on a trigger operation for the association control.

In some embodiments, the apparatus is further configured to: in response to detecting the trigger operation for the association control, determine whether a publication scope of the related document indicated by the related document identifier is a preset scope; if the publication scope is not the preset scope, display permission opening prompt information; in response to a trigger operation for the permission opening prompt information, display a permission opening interface, where the permission opening interface includes a permission change control; and update the publication scope of the related document based on an operation for the permission change control.

In some embodiments, the establishing an association relationship between the word to be edited and the information to be confirmed based on an operation for the information to be confirmed includes: in response to detecting the trigger operation for the association control, send an association relationship confirmation request; and in response to receiving an association success notification returned based on the association relationship confirmation request, display association success prompt information.

In some embodiments, the information to be confirmed includes a related user identifier; and the establishing an association relationship between the word to be edited and the information to be confirmed based on an operation for the information to be confirmed includes: displaying an association control corresponding to the related user identifier; and establishing an association relationship between the related word and the related user identifier based on a trigger operation for the related user identifier.

In some embodiments, the information to be confirmed includes a candidate definition of the related word; and the establishing an association relationship between the word to be edited and the information to be confirmed based on an operation for the information to be confirmed includes: displaying a confirmation control corresponding to the candidate definition; and establishing an association relationship between the related word and the candidate definition based on a trigger operation for the confirmation control.

In some embodiments, the displaying information to be confirmed of a word to be edited includes: displaying, in a word editing interface of the word to be edited, the information to be confirmed of the word to be edited. In some embodiments, the apparatus is further configured to: in response to a trigger operation of a user having an editing permission for a word to be edited for a predefined word editing entry control, display the word editing interface.

In some embodiments, the apparatus is further configured to: display prompt information corresponding to the information to be confirmed, where the prompt information is used to indicate at least one of the following of the information to be confirmed: a type, a source, and an operation prompt.

In some embodiments, the prompt information is displayed in a form of annotated content.

In some embodiments, the apparatus is further configured to: display feedback information in a word editing interface, where the feedback information includes improvement direction information for content to be edited of the word to be edited.

In some embodiments, the operation for the information to be confirmed includes at least one of the following: a deletion operation, a confirmation operation, and an editing operation.

In some embodiments, the displayed information to be confirmed includes at least one of the following types: a word definition, a related document, a related group, a related user identifier, a related link, and a related word, where the related link is used to indicate a carrier of the explanatory information.

In some embodiments, the apparatus is further configured to: mine, from a database, related information of the word to be edited and an expected contribution user.

In some embodiments, the related word of the first user is obtained through the following steps: in response to the first user being an expected contribution user of the word to be edited, using the related information of the word to be edited as the information to be confirmed, and using the word to be edited as the related word of the first user, and pushing the related word and the related information to the first user.

In some embodiments, the word editing page is obtained through the following steps: in response to receiving a get request for the word editing interface, sending, to a requesting user of the word editing interface, related information of the word to be edited as information to be confirmed.

In some embodiments, the mining, from a database, related information of the word to be edited and an expected contribution user includes: searching, in a document set, for a sentence including the word to be edited as a first sentence set; selecting, from the first sentence set, a first sentence that meets a preset definition sentence condition as a second sentence set; extracting a subject word in a second sentence in the second sentence set, and if the extracted subject word matches the word to be edited, determining a word definition of the word to be edited based on the second sentence.

In some embodiments, the mining, from a database, related information of the word to be edited and an expected contribution user includes: searching, in a document set, for a document including the word to be edited in a document title and/or document content as a first document set; determining a second document from the first document set based on the document title, to obtain a second document set, where the second document set includes a document that explains the word to be edited; and selecting a related document of the word to be edited from the second document set based on a correlation with the word to be edited and/or a document quality score.

In some embodiments, the correlation between the second document and the word to be edited is determined through a first step, where the first step includes: determining the correlation between the second document and the word to be edited based on at least one of the following: presentation information and search click information of the word to be edited in the second document, where the presentation information of the word to be edited in the second document is determined based on at least one of the following: a presentation position, a presentation style, and a quantity of occurrences, and the search click information is used to indicate: when the second document is included in a search result obtained by using the word to be edited as a search word, a click situation of the user on the second document.

In some embodiments, the document quality score is determined through a second step, where the second step includes: determining a document quality score of the second document based on reading data and evaluation data of the document in a preset time period.

In some embodiments, the mining, from a database, related information of the word to be edited and an expected contribution user includes: determining, based on user feature information and a correlation between a user and the word to be edited, an expected contribution value between the user and the word to be edited, where the expected contribution value is used to represent a probability of the user editing the word to be edited.

In some embodiments, the correlation is determined based on at least one of the following: a similarity between a word associated with the user and the word to be edited, and a quantity of times that the word to be edited is included in an interaction record of the user.

In some embodiments, the user feature information includes at least one of the following: a quantity of times that the user creates and/or updates a word; user reliability information, where the user reliability information is generated based on comment information of the user about the word and/or the document; and user identity information.

In some embodiments, the mining, from a database, related information of the word to be edited and an expected contribution user includes: determining a candidate related user identifier of the word to be edited based on behavior data of a user for the word to be edited; and determining a related user identifier of the word to be edited from candidate user identifiers of the word to be edited based on a relationship between the candidate related user identifier and related information associated with the word to be edited.

In some embodiments, the relationship between the candidate related user identifier and the related information associated with the word to be edited includes at least one of the following: whether the user is an owner of a related document of the word to be edited; whether the user is an administrator of a related group of the word to be edited; whether the user is a contributor to content of the word to be edited; and whether a schedule topic of the user in a preset time period includes the word to be edited.

In some embodiments, the mining, from a database, related information of the word to be edited and an expected contribution user includes: determining a correlation between the word to be edited and a candidate related word based on at least one of the following: co-occurrence information between words, whether words are associated with a same piece of related information, and whether a word definition includes another word; and determining a related word of the word to be edited based on the correlation.

Referring to FIG. 6, FIG. 6 shows an example system architecture in which an information processing method according to an embodiment of the present disclosure may be applied.

As shown in FIG. 6, the system architecture may include terminal devices 601, 602, and 603, a network 604, and a server 605. The network 604 is configured to provide a medium for a communication link between the terminal devices 601, 602, and 603 and the server 605. The network 604 may include various connection types, such as a wired and wireless communication link, an optical fiber cable, or the like.

The terminal devices 601, 602, and 603 may interact with the server 605 through the network 604, to receive or send a message. The terminal devices 601, 602, and 603 may be installed with various client applications, such as a web browser application, a search application, and a news information application. A client application in the terminal devices 601, 602, and 603 may receive an instruction of a user, and complete a corresponding function based on the instruction of the user, for example, adding corresponding information to information based on the instruction of the user.

The terminal devices 601, 602, and 603 may be hardware or software. When the terminal devices 601, 602, and 603 are hardware, the terminal devices 601, 602, and 603 may be various electronic devices with a display screen and that support web browsing, including but not limited to a smart phone, a tablet computer, an e-book reader, an MP3 (Moving Picture Experts Group Audio Layer III) player, an MP4 (Moving Picture Experts Group Audio Layer IV) player, a laptop computer, and a desktop computer. When the terminal devices 601, 602, and 603 are software, the terminal devices 601, 602, and 603 may be installed in the foregoing enumerated electronic devices. The terminal devices 601, 602, and 603 may be implemented as a plurality of software or software modules (for example, software or software modules used to provide distributed services), or may be implemented as a single software or software module. This is not specifically limited here.

The server 605 may be a server that provides various services, for example, receives an information get request sent by the terminal devices 601, 602, and 603, and obtains display information corresponding to the information get request in various manners based on the information get request. The server 605 then sends related data of the display information to the terminal devices 601, 602, and 603.

It should be noted that the information processing method provided in this embodiment of the present disclosure may be performed by a terminal device. Correspondingly, the information processing apparatus may be disposed in the terminal devices 601, 602, and 603. In addition, the information processing method provided in this embodiment of the present disclosure may also be performed by the server 605. Correspondingly, the information processing apparatus may be disposed in the server 605.

It should be understood that the quantities of the terminal devices, the network, and the server in FIG. 6 are merely illustrative. Depending on implementation requirements, there may be any quantity of terminal devices, networks, and servers.

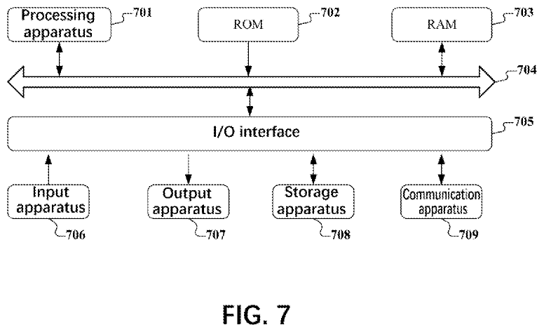

Reference is made to FIG. 7 below, which is a schematic diagram of a structure of an electronic device (for example, the terminal device or the server in FIG. 6) suitable for implementing the embodiments of the present disclosure. The terminal device in this embodiment of the present disclosure may include, but is not limited to, mobile terminals such as a mobile phone, a notebook computer, a digital broadcast receiver, a PDA (personal digital assistant), a tablet computer (PAD), a portable multimedia player (PMP), and a vehicle-mounted terminal (for example, a vehicle navigation terminal), and fixed terminals such as a digital TV and a desktop computer. The electronic device shown in FIG. 7 is merely an example, and shall not impose any limitation on the function and scope of use of the embodiments of the present disclosure.

As shown in FIG. 7, the electronic device may include a processing apparatus (for example, a central processing unit, a graphics processing unit, etc.) 701 that may perform a variety of appropriate actions and processing in accordance with a program stored in a read-only memory (ROM) 702 or a program loaded from a storage apparatus 708 into a random access memory (RAM) 703. The RAM 703 further stores various programs and data required for the operation of the electronic device 700. The processing apparatus 701, the ROM 702, and the RAM 703 are connected to each other through a bus 704. An input/output (I/O) interface 705 is also connected to the bus 704.

Generally, the following apparatuses may be connected to the I/O interface 705: an input apparatus 706 including, for example, a touchscreen, a touchpad, a keyboard, a mouse, a camera, a microphone, an accelerometer, and a gyroscope; an output apparatus 707 including, for example, a liquid crystal display (LCD), a speaker, and a vibrator; the storage apparatus 708 including, for example, a tape and a hard disk; and a communication apparatus 709. The communication apparatus 709 may allow the electronic device to perform wireless or wired communication with other devices to exchange data. Although FIG. 7 shows the electronic device having various apparatuses, it should be understood that it is not required to implement or have all of the shown apparatuses. It may be an alternative to implement or have more or fewer apparatuses.

In particular, according to an embodiment of the present disclosure, the process described above with reference to the flowcharts may be implemented as a computer software program. For example, this embodiment of the present disclosure includes a computer program product, which includes a computer program carried on a non-transitory computer-readable medium, where the computer program includes program code for performing the method shown in the flowchart. In such an embodiment, the computer program may be downloaded from a network through the communication apparatus 709 and installed, installed from the storage apparatus 708, or installed from the ROM 702. When the computer program is executed by the processing apparatus 701, the above-mentioned functions defined in the method of the embodiment of the present disclosure are performed. It should be noted that the foregoing computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. A more specific example of the computer-readable storage medium may include, but is not limited to: an electrical connection having one or more wires, a portable computer magnetic disk, a hard disk, a random access memory (RAM), a read-only memory (ROM), an erasable programmable read-only memory (EPROM or flash memory), an optic fiber, a portable compact disk read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

In some implementations, the client and the server may communicate using any currently known or future-developed network protocol such as a hypertext transfer protocol (HTTP), and may be connected to digital data communication (for example, a communication network) in any form or medium. Examples of the communication network include a local area network (“LAN”), a wide area network (“WAN”), an internetwork (for example, the Internet), a peer-to-peer network (for example, an ad hoc peer-to-peer network), and any currently known or future-developed network.

The foregoing computer-readable medium may be contained in the foregoing electronic device. Alternatively, the computer-readable medium may exist independently, without being assembled into the electronic device.

The foregoing computer-readable medium carries one or more programs that, when executed by the electronic device, cause the electronic device to perform the following operations: displaying information to be confirmed of a word to be edited; and establishing an association relationship between the word to be edited and the information to be confirmed based on an operation for the information to be confirmed, where the information to be confirmed is configured to provide explanatory information of the word to be edited.

The computer program code for performing operations in the present disclosure may be written in one or more programming languages or a combination thereof, where the programming languages include but are not limited to an object-oriented programming language, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the circumstance involving the remote computer, the remote computer may be connected to the computer of the user over any type of network, including a local area network (LAN) or a wide area network (WAN), or may be connected to an external computer (for example, connected over the Internet using an Internet service provider).

The flowcharts and block diagrams in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by means of software, or may be implemented by means of hardware. The name of a unit does not constitute a limitation on the unit itself in some cases, for example, a selection unit may also be described as “a unit for selecting a first-type pixel”.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system on chip (SOC), a complex programmable logic device (CPLD), and the like.

In the context of the present disclosure, a machine-readable medium may be a tangible medium containing or storing a program used by or in combination with an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, apparatuses, or devices, or any suitable combination thereof. A more specific example of the machine-readable storage medium may include an electrical connection based on one or more wires, a portable computer disk, a hard disk, a random access memory (RAM), a read-only memory (ROM), an erasable programmable read-only memory (EPROM or flash memory), an optic fiber, a portable compact disk read-only memory (CD-ROM), an optical storage device, a magnetic storage device, or any suitable combination thereof.

The foregoing descriptions are merely preferred embodiments of the present disclosure and explanations of the applied technical principles. Persons skilled in the art should understand that the scope of disclosure involved in the present disclosure is not limited to the technical solutions formed by specific combinations of the foregoing technical features, and shall also cover other technical solutions formed by any combination of the foregoing technical features or equivalent features thereof without departing from the foregoing concept of disclosure. For example, the technical solutions formed by replacing the foregoing features with technical features with similar functions disclosed in the present disclosure (but not limited to).

In addition, although the various operations are depicted in a specific order, it should be understood as requiring these operations to be performed in the specific order shown or in a sequential order. Under specific circumstances, multitasking and parallel processing may be advantageous. Similarly, although several specific implementation details are contained in the foregoing discussions, these details should not be construed as limiting the scope of the present disclosure. Some features that are described in the context of separate embodiments may also be implemented in combination in a single embodiment. In contrast, various features described in the context of a single embodiment may alternatively be implemented in a plurality of embodiments individually or in any suitable sub-combination.

Although the subject matter has been described in a language specific to structural features and/or logical actions of the method, it should be understood that the subject matter specified in the appended claims is not necessarily limited to the specific features or actions described above. In contrast, the specific features and actions described above are merely exemplary forms of implementing the claims.

1. An information processing method, comprising:
displaying information to be confirmed of a word to be edited; and
establishing an association relationship between the word to be edited and the information to be confirmed based on an operation for the information to be confirmed,
where the information to be confirmed is configured to provide explanatory information of the word to be edited.

2. The method according to claim 1, wherein the word to be edited comprises a related word pushed to a first user.

3. The method according to claim 1, wherein the method further comprises:
in response to a predefined expansion operation for the related word, displaying a definition of the related word, so that the first user determines whether to perform the confirmation operation based on the definition.

4. The method according to claim 2, wherein the method further comprises at least one of:
displaying a word to be created by the first user, and displaying a creation control in a corresponding manner to the word to be created; and in response to a trigger operation for the creation control, displaying a word editing interface;
or
in response to the confirmation operation, displaying a word editing entry control of the related word; and in response to a trigger operation for the word editing entry control, displaying a word editing interface of the related word;
or
in response to the confirmation operation, displaying editing prompt information of the related word, and displaying a word editing entry control corresponding to the editing prompt information; and in response to a trigger operation for the word editing entry control, displaying a word editing interface of the related word.

5. (canceled)

6. (canceled)

7. The method according to claim 2, wherein the information to be confirmed comprises a related document identifier; and
the establishing an association relationship between the word to be edited and the information to be confirmed based on an operation for the information to be confirmed comprises:
displaying an association control corresponding to the related document identifier; and
establishing an association relationship between the related word and a related document indicated by the related document identifier based on a trigger operation for the association control.

8. The method according to claim 7, wherein the method further comprises:
in response to detecting the trigger operation for the association control, determining whether a publication scope of the related document indicated by the related document identifier is a preset scope;
if the publication scope is not the preset scope, displaying permission opening prompt information;
in response to a trigger operation for the permission opening prompt information, displaying a permission opening interface, wherein the permission opening interface comprises a permission change control; and
updating the publication scope of the related document based on an operation for the permission change control.

9. The method according to claim 1, wherein the establishing an association relationship between the word to be edited and the information to be confirmed based on an operation for the information to be confirmed comprises:
in response to detecting the trigger operation for the association control, sending an association relationship confirmation request; and
in response to receiving an association success notification returned based on the association relationship confirmation request, displaying association success prompt information.

10. The method according to claim 1, wherein at least one of:
the information to be confirmed comprises a related user identifier; and the establishing an association relationship between the word to be edited and the information to be confirmed based on an operation for the information to be confirmed comprises: displaying an association control corresponding to the related user identifier; and
establishing an association relationship between the related word and the related user identifier based on a trigger operation for the related user identifier,
or
the information to be confirmed comprises a candidate definition of the related word; and the establishing an association relationship between the word to be edited and the information to be confirmed based on an operation for the information to be confirmed comprises: displaying a confirmation control corresponding to the candidate definition; and
establishing an association relationship between the related word and the candidate definition based on a trigger operation for the confirmation control.

11. (canceled)

12. The method according to claim 1, wherein the displaying information to be confirmed of a word to be edited comprises:
displaying, in a word editing interface of the word to be edited, the information to be confirmed of the word to be edited.

13. The method according to claim 12, wherein the method further comprises at least one of:
in response to a trigger operation of a user having an editing permission for a word to be edited for a predefined word editing entry control, displaying the word editing interface;
or displaying prompt information corresponding to the information to be confirmed, wherein the prompt information is used to indicate at least one of the following of the information to be confirmed: a type, a source, and an operation prompt;
or
displaying feedback information in a word editing interface, wherein the feedback information includes improvement direction information for content to be edited of the word to be edited.

14. (canceled)

15. The method according to claim 13, wherein the prompt information is displayed in a form of annotated content.

16. (canceled)

17. The method according to claim 12, wherein at least one of:
the operation for the information to be confirmed comprises at least one of the following: a deletion operation, a confirmation operation, and an editing operation;
or
the displayed information to be confirmed comprises at least one of the following types: a word definition, a related document, a related group, a related user identifier, a related link, and a related word, where the related link is used to indicate a carrier of the explanatory information.

18. (canceled)

19. The method according to claim 1, wherein the method further comprises:
mining, from a database, related information of the word to be edited and an expected contribution user.

20. The method according to claim 19, wherein at least one of:
the related word of the first user is obtained through the following steps: in response to the first user being an expected contribution user of the word to be edited, using the related information of the word to be edited as the information to be confirmed, and using the word to be edited as the related word of the first user, and pushing the related word and the related information to the first user;
or
the word editing page is obtained through the following steps: in response to receiving a get request for the word editing interface, sending, to a requesting user of the word editing interface, related information of the word to be edited as information to be confirmed;
or
the mining, from a database, related information of the word to be edited and an expected contribution user comprises: searching, in a document set, for a sentence including the word to be edited as a first sentence set; selecting, from the first sentence set, a first sentence that meets a preset definition sentence condition as a second sentence set; and extracting a subject word in a second sentence in the second sentence set, and if the extracted subject word matches the word to be edited, determining a word definition of the word to be edited based on the second sentence;
or
wherein the mining, from a database, related information of the word to be edited and an expected contribution user comprises: searching, in a document set, for a document including at least one of the word to be edited in a document title or document content as a first document set;
determining a second document from the first document set based on the document title, to obtain a second document set, wherein the second document set includes a document that explains the word to be edited; and selecting a related document of the word to be edited from the second document set based on a correlation with at least one of the word to be edited or a document quality score;
or
the mining, from a database, related information of the word to be edited and an expected contribution user comprises: determining, based on user feature information and a correlation between a user and the word to be edited, an expected contribution value between the user and the word to be edited, wherein the expected contribution value is used to represent a probability of the user editing the word to be edited;
or
the mining, from a database, related information of the word to be edited and an expected contribution user comprises: determining a candidate related user identifier of the word to be edited based on behavior data of a user for the word to be edited; and determining a related user identifier of the word to be edited from candidate user identifiers of the word to be edited based on a relationship between the candidate related user identifier and related information associated with the word to be edited;
or
the mining, from a database, related information of the word to be edited and an expected contribution user comprises: determining a correlation between the word to be edited and a candidate related word based on at least one of the following: co-occurrence information between words, whether words are associated with a same piece of related information, and whether a word definition includes another word; and determining a related word of the word to be edited based on the correlation.

21. (canceled)

22. (canceled)

23. (canceled)

24. The method according to claim 20, wherein at least one of:
the correlation between the second document and the word to be edited is determined through a first step, wherein the first step comprises:
determining the correlation between the second document and the word to be edited based on at least one of the following: presentation information and search click information of the word to be edited in the second document, wherein the presentation information of the word to be edited in the second document is determined based on at least one of the following: a presentation position, a presentation style, and a quantity of occurrences, and the search click information is used to indicate: when the second document is included in a search result obtained by using the word to be edited as a search word, a click situation of the user on the second document;
or
the document quality score is determined through a second step, wherein the second step comprises: determining a document quality score of the second document based on reading data and evaluation data of the document in a preset time period.

25. (canceled)

26. (canceled)

27. The method according to claim 20, wherein the correlation is determined based on at least one of the following: a similarity between a word associated with the user and the word to be edited, and a quantity of times that the word to be edited is included in an interaction record of the user.

28. The method according to claim 20, wherein the user feature information comprises at least one of the following:
a quantity of times that the user at least one of creates or updates a word;
user reliability information, wherein the user reliability information is generated based on comment information of the user about at least one of the word or the document; and
user identity information.

29. (canceled)

30. The method according to claim 20, wherein the relationship between the candidate related user identifier and the related information associated with the word to be edited comprises at least one of the following:
whether the user is an owner of a related document of the word to be edited;
whether the user is an administrator of a related group of the word to be edited;
whether the user is a contributor to content of the word to be edited; and
whether a schedule topic of the user in a preset time period includes the word to be edited.

31. (canceled)

32. (canceled)

33. An electronic device, comprising:
one or more processors; and
a storage apparatus, configured to store one or more programs,
wherein the one or more programs, when executed by the one or more processors, cause the one or more processors to implement an information processing method, comprising:
displaying information to be confirmed of a word to be edited; and
establishing an association relationship between the word to be edited and the information to be confirmed based on an operation for the information to be confirmed,
where the information to be confirmed is configured to provide explanatory information of the word to be edited.

34. A non-transitory computer-readable medium having a computer program stored thereon, wherein when the program is executed by a processor, an information processing method is implemented, comprising:
displaying information to be confirmed of a word to be edited; and
establishing an association relationship between the word to be edited and the information to be confirmed based on an operation for the information to be confirmed,
where the information to be confirmed is configured to provide explanatory information of the word to be edited.
